(19) United States
(12) Patent Application Publication
(10) Pub. No.: US 2026/0059245 A1
(43) Pub. Date: Feb. 26, 2026

(54) HEARING DEVICE ADAPTATION BASED ON INFERENCES FROM USER INTERACTION AND USE CONTEXT

(71) Applicant: Starkey Laboratories, Inc., Eden Prairie, MN (US)

(72) Inventors: Golbarg Mehraei, Newtonville, MA (US); Kenneth Kragh Jensen, Shakopee, MN (US); Martin McKinney, Minneapolis, MN (US)

(21) Appl. No.: 19/295,881

(22) Filed: Aug. 11, 2025

Related U.S. Application Data
(60) Provisional application No. 63/685,028, filed on Aug. 20, 2024.

(51) Int. Cl. H04R 25/00

(52) U.S. Cl. CPC H04R 25/43; H04R 25/558; H04R 25/70; H04R 25/75; H04R 2225/41; H04R 2225/43; H04R 2225/55; H04R 2225/81

(57) ABSTRACT

A hearing system comprises a hearing device configured to be worn by a wearer, the hearing device comprising one or more microphones, an acoustic transducer, audio circuitry coupled to the one or more microphones and the acoustic transducer, and a controller coupled to the audio circuitry. The controller is configured to detect a wearer interaction with the hearing device, determine a context of the wearer's use of the hearing device, obtain user data for groups of a population of hearing device users based on user interaction with, and context of use of, the users' hearing devices, determine an operational change to the hearing device based on the wearer interaction, the context, and the user data that corresponds to the wearer's interaction and context, and apply the operational change to the hearing device.

This application claims the benefit of U.S. Provisional Application No. 63/685,028, filed Aug. 20, 2024, the entire content of each of which is hereby incorporated by reference.

### TECHNICAL FIELD

This application relates generally to ear-level electronic systems and devices, including hearing devices, personal amplification devices, hearing aids, hearables, and other ear-worn electronic devices.

### SUMMARY

Embodiments are directed to systems and methods for implementing hearing device adaptation based on inferences from user interaction with the hearing device and the context of hearing device use. A hearing system comprises a hearing device worn by a wearer. The hearing system is configured to detect a wearer interaction with the hearing device, determine a context of the wearer's use of the hearing device, determine an operational change to the hearing device based on the wearer interaction and the context, and apply the operational change to the hearing device.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 is an illustration of a hearing system in accordance with any of the embodiments disclosed herein.

FIG. 2 illustrates a method implemented by a hearing device in accordance with any of the embodiments disclosed herein.

FIGS. 3A and 3B are graphs showing various hearing device interactions associated with different groups of hearing device users in accordance with any of the embodiments disclosed herein.

FIG. 4 is a graph showing various hearing device usage patterns associated with different groups of hearing device users in accordance with any of the embodiments disclosed herein.

FIG. 5A is a graph showing average hourly memory change associated with different groups of hearing device users as a function of length of use in accordance with any of the embodiments disclosed herein.

FIG. 5B is a graph showing average hourly volume increment associated with different groups of hearing device users as a function of length of use in accordance with any of the embodiments disclosed herein.

FIG. 5C is a graph showing average volume decrement associated with different groups of hearing device users as a function of length of use in accordance with any of the embodiments disclosed herein.

FIGS. 6A-6C show memory change, volume increment, and volume decrement data associated with different groups of hearing device users for five different acoustic environments in accordance with any of the embodiments disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Hearing devices, such as hearing aids, may not always deliver the optimal sound for a particular wearer and a particular situation. The hearing device wearer may need to manually intervene to adjust the hearing device to meet their personal preference. Sometimes, the wearer may be successful, but the need for manual intervention may be inconvenient. In some instances, the wearer's manual intervention may not be successful, so the wearer may have a sub-optimal hearing experience.

In this disclosure, the term hearing system is used, which refers to a hearing device, such as a hearing aid, or a hearing device in combination with an external electronic device. The external electronic device can be a smartphone, watch, accessory such as a table microphone, or a resource connected through the Internet. The hearing system may detect a wearer interaction with a component of the hearing system, determine a context of the hearing device wearer, and determine a change to the operation of the hearing device based on both the wearer interaction and the context. Notably, the change to the operation of the hearing device is not the direct result of the hearing device interaction. For example, the change to the operation of the hearing device is not simply a response to an input through a user interface, such as a volume increase responsive to a volume up input, or an activation of a feature or setting responsive to an input corresponding to the feature or setting.

A hearing system may gather information about wearer's interactions with the hearing device (e.g., hearing aid) and combine that interaction information with other information about the context of the use of the hearing device by the wearer to determine a modification to the operation of the hearing device (e.g., feature activation or setting change) or a recommendation to make such a modification.

The wearer's interaction with the hearing device may, for example, include a setting change (e.g., volume increase or decrease), a program change (e.g., from “home” program (e.g., “memory”) to “restaurant” program), an activation of a feature (e.g., turn on adaptive tuning or turn on noise suppression), a deactivation of a feature (e.g., turn off adaptive tuning), a manual tuning or manipulation of a feature (e.g., equalizer adjustment), an interaction with a smartphone application (e.g., look up help topic for a feature), a use of a voice assistant (e.g., detect a request such as “How do I turn on adaptive tuning feature?” or “Help me reduce the water noise”), a use of an accessory (e.g., connection to a table microphone) or a powering on or off of the device.

The context of the hearing device wearer may, for example, include the acoustic environment (e.g., an environmental classification, such as speech in noise, speech in quiet, noise, music), a signal-to-noise ratio, a type of noise (e.g., water noise, machine noise, wind noise or babble), an activity (e.g., walking, running, biking, sitting as determined using a sensor such as an inertial measurement unit (IMU) or an accelerometer), a location (e.g., in a restaurant as determined by a Bluetooth beacon or a GPS sensor), a time of day, an emotional status (e.g., lonely, or happy, as determined using a processor and microphone on the hearing device or accessory (e.g., smartphone) and optionally also using a physiologic sensor), a health status (e.g., as determined by a sensor that may detect heart rate variability, body temperature or blood pressure), a conversational pattern (e.g., asking a speaker to repeat a statement, or turn-taking in conversation or disconnection therefrom, or a speech pattern that is indicative of a difficulty in communication (e.g., Lombard effect.), or an explicit listening intent (e.g., as received via a smartphone or watch or through a hearing device microphone or button or sensor (e.g., tap sensor), or an inferred listening intent (e.g., intent determined from an acoustic environment or communication pattern and optionally also sensor data (e.g., IMU data to indicate head motion).

A hearing system may use information about the wearer's interaction with the hearing device, in combination with context of the wearer's use, to determine a change to the hearing device operation, which may be automatically implemented to improve the wearer's experience (e.g., automatically applied without user interaction, or automatically applied in response to a user request or affirmation of a prompt), or the change to the hearing device operation may be recommended to the wearer or to a caregiver or to a hearing professional. Alternatively, another suggested course of action (e.g., a cleaning or maintenance of the device, a virtual or in-person visit with a hearing professional, or a device upgrade) may be recommended to the wearer and/or the hearing professional.

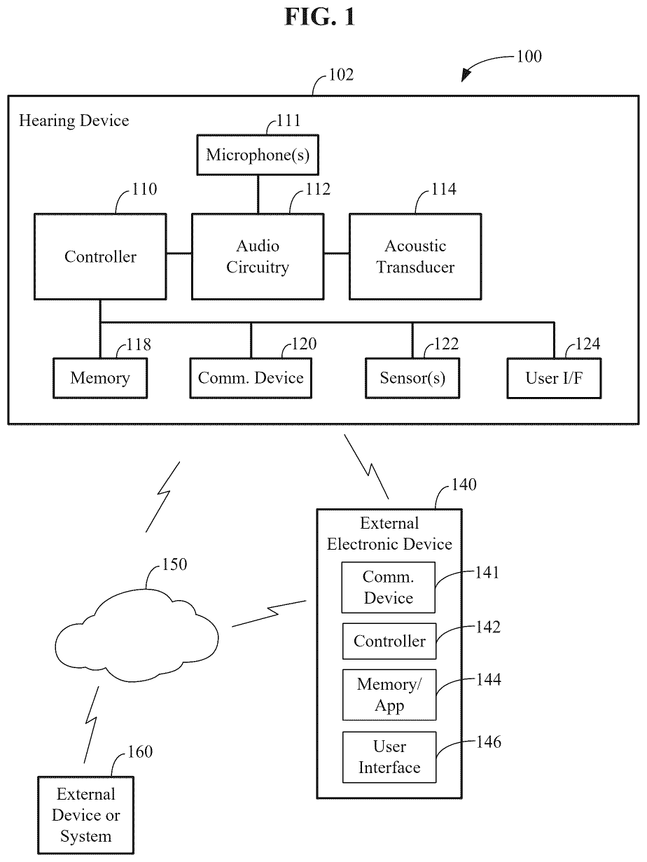

FIG. 1 is a block diagram of a representative hearing device 100 configured to implement hearing device adaptation based on inferences derived from wearer interaction with the hearing device and the context of hearing device usage in accordance with any of the embodiments disclosed herein. The hearing device 100 is representative of a wide variety of electronic devices configured to be deployed in an car of a user. Representative hearing devices 100 include, but are not limited to, in-the-canal (ITC), completely-in-the-canal (CIC), invisible-in-canal (IIC), in-the-car (ITE), behind-the-car (BTE), and receiver-in-canal (RIC) type devices. Representative hearing devices of the present disclosure include, but are not limited to, hearing aids, earbuds, electronic car plugs, personal sound amplification devices, bone conduction hearing devices, and other car-worn electronic appliances. Hearing devices of the present disclosure include restricted medical devices (e.g., devices regulated by the U.S. Food and Drug Administration), such as hearing aids. Hearing devices of the present disclosure include consumer electronic devices, such as consumer earbuds, consumer sound amplifiers, and consumer hearing devices (e.g., consumer hearing aids and over-the-counter (OTC) hearing devices), for example. Throughout this disclosure, reference is made to a “hearing device,” which is understood to refer to a system comprising a single left ear device, a single right car device, or a combination of a left ear device and a right car device.

The representative hearing device 100 shown in FIG. 1 includes a housing 102 configured for deployment in an car of a user. According to some embodiments disclosed herein, the housing 102 can be configured for deployment at least partially within the user's car. For example, the housing 102 can be configured for deployment at least partially or entirely within an car canal of the user's ear. The housing 102 can be configured for deployment at least partially within the outer car, such as from the helix to the car canal (e.g., the concha cymba, concha cavum) and can extend up to or into the car canal. In some configurations, the shape of the housing 102 can be customized for the user's ear canal (e.g., based on a mold taken from the user's ear canal). In other configurations, the housing 102 can be constructed from pliant (e.g., semisoft) material which, when inserted into the user's car canal, takes on the shape of the car canal.

The housing 102 is configured to contain or support a number of components, a subset of which are illustrated in FIG. 1. The hearing device 100 includes a controller 110 which can include one or more processors or other logic devices. For example, the controller 110 can be representative of one or any combination of one or more logic devices (e.g., multi-core processor, digital signal processor (DSP), microprocessor, programmable controller, general-purpose processor, special-purpose processor, hardware controller, software controller, a combined hardware and software device), and/or other digital logic circuitry (e.g., ASICs, FPGAs). The controller 110 can include or be coupled to a memory 118. The memory 118 can include one or more types of memory, including ROM, RAM, SDRAM, NVRAM, EEPROM, and FLASH, for example. The memory 118 can store software/firmware which can be executed by the controller 110 to implement the functionality disclosed herein. For example, the memory 118 can store software which can be executed by the controller 110 when implementing hearing device adaptation based on inferences derived from wearer interaction with the hearing device and the context of hearing device usage.

The hearing device 100 includes audio circuitry 112 coupled to the controller 110, one or more microphones 111, and an acoustic transducer 114. The audio circuitry 112 can include an analog front end configured to filter and amplify electrical signals received from the one or more microphones 111. The audio circuitry 112 can convert the microphone electrical signals from analog to digital signals so that the digital signals can be further processed and/or analyzed by the controller 110 (e.g., a DSP integral or coupled to the controller 110). The audio circuitry 112 can convert digital signals to analog signals and communicate these signals to the acoustic transducer 114. In response to the analog signals, the acoustic transducer 114 (e.g., a receiver) generates sound which can be communicated to the wearer's eardrum.

A communication device 120 of the hearing device 100 can include a radiofrequency (RF) transceiver and an antenna. For example, the communication device 120 can incorporate an antenna arrangement coupled to a high-frequency radio, such as a 2.4 GHz radio. The radio can conform to an IEEE 802.11 (e.g., WiFi®) or Bluetooth® (e.g., Bluetooth® Low Energy) specification, for example. The communication device 120 is configured to facilitate communication between the hearing device 100 and an external electronic device 140, such as a smartphone, watch, tablet, or small computer.

The hearing device 100 includes a user interface 124 coupled to the controller 110. The user interface 124 can include one or more buttons, one or more switches (e.g., toggle and/or rocker switches), and/or a sensor 122 (e.g., IMU or accelerometer) configured to sense a tap or touch applied to hearing device 100 by the wearer. The user interface 124 may also include a gesture detection capability involving the use of the communication device 120, such as disclosed in U.S. Patent Application Publication 2022/0109925, which is incorporated herein by reference.

The sensors 122 of the hearing device can include one or more physiologic sensors. A non-exhaustive, representative list of physiologic signals or conditions of the wearer that can be sensed by the sensors 122 and monitored by the hearing device 100 includes brain activity (EEG), heart activity (heart rate, heart rate variability via a pulse oximeter or PPG sensor), breathing activity, body temperature (via thermocouple, thermistor, RTD temperature sensors), electrodermal activity, eye movement, and blood pressure.

The external electronic device 140 includes a communication device 141 (e.g., an IEEE 802.11 compliant radio or BLE radio) configured to communicatively couple to the communication device 120 of the hearing device 100. The external electronic device 140 includes a controller 142 coupled to memory 144 and a user interface 146. The controller 142 and memory 144 can be configured in a manner described above. The user interface 146 can include a touch display and an audio processing facility (e.g., including a speaker and a microphone). The memory 144 is configured to store an app which, when executed by the controller 142, facilitates interaction between the user and the hearing device 100.

The wearer's interaction with the hearing device 100 can be detected by the controller 110 of the hearing device 100 and recorded in the memory 118. The wearer's interaction can be communicated from the memory 118 of the hearing device 100 to the memory 144 of the external electronic device 140. The context of the wearer's use of the hearing device 100 can be determined by the controller 110 and recorded in the memory 118. The context information can be communicated from the memory 118 of the hearing device 100 to the memory 144 of the external electronic device 140. Alternatively, or in addition, the context of the wearer's use of the hearing device 100 can be determined by the controller 142 of the external electronic device 140. The controller 110 of the hearing device 100 and/or the controller 142 of the external electronic device 140 can be configured to determine a change to the hearing device operation based on the wearer interaction information and the context of use information.

The controller 110 of the hearing device 100 and/or the controller 142 of the external electronic device 140 can be configured to obtain user data for groups of a population of hearing device users based on user interaction with, and context of use of, the users' hearing devices. The user data can be obtained from a cloud database or cloud processor, for example. The user data can alternatively be obtained from a memory of the external electronic device. The controller 110 and/or the controller 142 can be configured to determine an operational change to the hearing device based on the wearer interaction, the context, and the user data that corresponds to the wearer's interaction and context. The controller 110 and/or the controller 142 can be configured to apply the operational change to the hearing device.

The change to the hearing device operation can be implemented by the controller 110/142 automatically without wearer interaction to improve the wearer's experience. The change can be automatically implemented by the controller 110/142 in response to a wearer request (e.g., via microphone 111 or user interface 124/146) or affirmation of a prompt (e.g., received by microphone 111 or user interface 124/146). For example, the change to the hearing device operation may be recommended to the wearer who can accept or reject the recommendation (e.g., via microphone 111 or user interface 124/146). The change to the hearing device operation may be recommended to a caregiver or to a hearing professional via the cloud 150 and an external device or system 160 (e.g., smartphone, tablet, laptop, desk-top PC, server). Alternatively, or in addition, a course of action can be recommended by the controller 110/142 to the wearer and/or hearing professional, such as a cleaning or maintenance of the hearing device 100, a virtual or in-person visit with the hearing professional or a hearing device upgrade.

Example Ex1. A method implemented by a hearing system comprising a hearing device worn by a wearer, the method comprising detecting a wearer interaction with the hearing device, determining a context of the wearer's use of the hearing device, obtaining user data for groups of a population of hearing device users based on user interaction with, and context of use of, the users' hearing devices, determining an operational change to the hearing device based on the wearer interaction, the context, and the user data that corresponds to the wearer's interaction and context, and applying the operational change to the hearing device.

Example Ex2. The method of Ex1, wherein applying the operational change to the hearing device comprises adjusting the sound output by the hearing device.

Example Ex3. The method of Ex1, comprising one or both of generating and delivering a notification to the wearer suggesting or offering the operational change to the hearing device, and generating and delivering a notification to a hearing professional suggesting the operational change to the hearing device.

Example Ex4. The method of Ex1, wherein the hearing system comprises the hearing device communicatively coupled to an external electronic device, and the method is implemented by cooperative operation of the hearing device and the external electronic device.

Example Ex5. The method of Ex1, wherein the context comprises one of both of an acoustic context and an activity context of the wearer.

Example Ex6. The method of Ex1, wherein the context comprises one or both of a location of the wearer and time of day.

Example Ex7. The method of Ex1, wherein the context comprises one or both of an emotional status of the wearer and a health status of the wearer.

Example Ex8. The method of Ex1, wherein the context comprises one or both of conversational patterns involving the wearer and a listening intent of the wearer.

Example Ex9. The method of Ex1, wherein the wearer interaction comprises one or both of wearer manipulation of a user interface of the hearing device and wearer manipulation of an app implemented by a user interface of an external electronic device communicatively coupled with the hearing device.

Example Ex10. The method of Ex1, wherein the wearer interaction comprises one or more of changing a volume of the hearing device, activating, deactivating, and/or adjusting a feature of the hearing device, changing a memory of the hearing device, and tuning an equalizer of the hearing device.

Example Ex11. The method of Ex1, wherein the wearer interaction comprises one or more of activating, deactivating, and/or adjusting a noise suppression feature of the hearing device, activating, deactivating, and/or adjusting an adaptive tuning feature of the hearing device, activating, deactivating, and/or adjusting a tinnitus masking feature of the hearing device, activating and deactivating a stream boost feature of the hearing device, and powering on the hearing device and powering off the hearing device

Example Ex12. A hearing system comprises a hearing device configured to be worn by a wearer, the hearing device comprising one or more microphones, an acoustic transducer, audio circuitry coupled to the one or more microphones and the acoustic transducer, and a controller coupled to the audio circuitry. The controller is configured to detect a wearer interaction with the hearing device, determine a context of the wearer's use of the hearing device, obtain user data for groups of a population of hearing device users based on user interaction with, and context of use of, the users' hearing devices, determine an operational change to the hearing device based on the wearer interaction, the context, and the user data that corresponds to the wearer's interaction and context, and apply the operational change to the hearing device.

Example Ex13. The system of Ex12, comprising an external electronic device communicatively coupled with the hearing device, the external electronic device comprising a user interface configured to implement an app for interacting with the hearing device.

Example Ex14. The system of Ex12, wherein applying the operational change to the hearing device by the controller comprises adjusting the sound output by the acoustic transducer.

Example Ex15. The system of Ex12, wherein the controller is configured to generate and deliver a notification to the wearer suggesting or offering the operational change to the hearing device and/or generate and deliver a notification to a hearing professional suggesting the operational change to the hearing device.

Example Ex16. The system of Ex12, wherein the context comprises one of both of an acoustic context and an activity context of the wearer.

Example Ex17. The system of Ex12, wherein the context comprises one or both of a location of the wearer and time of day.

Example Ex18. The system of Ex12, wherein the context comprises one or both of an emotional status of the wearer and a health status of the wearer.

Example Ex19. The system of Ex12, wherein the context comprises one or both of conversational patterns involving the wearer and a listening intent of the wearer.

Example Ex20. The system of Ex12, wherein the wearer interaction comprises one or more of changing a volume of the hearing device, activating, deactivating, and/or adjusting a feature of the hearing device, changing a memory of the hearing device, and tuning an equalizer of the hearing device.

Example Ex21. The system of Ex12, wherein the wearer interaction comprises one or more of activating, deactivating, and/or adjusting a noise suppression feature of the hearing device, activating, deactivating, and/or adjusting an adaptive tuning feature of the hearing device, activating, deactivating, and/or adjusting a tinnitus masking feature of the hearing device, activating and deactivating a stream boost feature of the hearing device, and powering on the hearing device and powering off the hearing device.

The following are representative examples of wearer interactions with a hearing device 100 and/or hearing system (hearing device 100 in combination with an external electronic device 140) in accordance with any of the embodiments disclosed herein.

The wearer interactions can include changing the volume of the sound produced by the hearing device 100. Such changes in the volume include an increase in volume and a decrease in volume. The wearer can make changes to the volume via one or more switches (e.g., a rocker switch) or buttons on the user interface 124 of the hearing device 100, or buttons on the user interface 146 of the external electronic device 140.

The wearer interactions can include a memory (program) change, which can be made via a switch or button on the user interface 124 of the hearing device 100 (e.g., cycling through available memories) or buttons on the user interface 146 of the external electronic device 140. For example, the wearer can select a memory or program such as “restaurant,” “music,” “tinnitus,” or a custom program, among others.

The wearer interactions can include a feature activation, a feature deactivation, or tuning of a feature. For example, the wearer interactions can involve tuning of an equalizer, which can be implemented by use of the user interface 146 of the external electronic device 140. For example, the user can adjust different bands of the equalizer, such as a high frequency band (treble), a mid-frequency band (middle), and a low frequency band (bass) of the equalizer.

Another feature that can be activated, deactivated or tuned by the wearer is noise suppression and the aggressiveness of the noise suppression. It is understood that there is a trade-off between noise suppression and distortion. A particular wearer may have a clarity preference in which more noise is tolerable. Other wearers may have a comfort preference in which less noise is preferred. The wearer can select the degree of noise suppression to suit their preference via the user interface 146 of the external electronic device 140.

An adaptive tuning feature represents another feature that can be activated, deactivated, or tuned by the wearer. Aspects of a representative adaptive tuning feature, referred to as Edge Mode, are disclosed in U.S. Patent Application Publication No. 2022/0369048 and U.S. Pat. No. 12,035,107, which are incorporated herein by reference. Aspects of another representative adaptive tuning feature in the context of muffled speech, referred to as Masked Mode, are disclosed in U.S. Patent Application Publication No. 2023/0353957, which is incorporated herein by reference.

The adaptive tuning feature may allow the wearer to express an explicit listening intent, such as an overall “best sound” for best overall sound, or “enhance speech” to allow the wearer to hear people more clearly, or “reduce noise” to provide extra comfort in a noisy environment. The adaptive tuning feature may adjust parameters to provide a listening experience consistent with the wearer's listening intent, e.g., to provide more clarity or to reduce noise. The hearing system may learn the wearer's preference for the selected listening intent in the particular context (e.g., in the acoustic environment) and strengthen the adaptation for that intent.

The hearing device may include a sound generator configured to produce a tinnitus masking sound. A tinnitus masking feature can be activated, deactivated, or tuned by the wearer. For example, the tinnitus masking sound can be tuned by adjusting one or more of a loudness level, a bandwidth, a noise type, a pitch, a frequency composition, and a frequency shaping of the tinnitus masking sound produced by the sound generator. The hearing device can implement a tinnitus masking feature according to the disclosures of U.S. Patent Application Publication Nos. 2020/0228905 and 2022/0210586, which are incorporated herein by reference.

Another feature that can be activated or deactivated by the wearer is stream boost when streaming music or listening to sound from a sound source (e.g., a television set-top box). The boosted sound presented to the wearer during streaming can have a fixed gain and fixed equalizer settings, for example.

Wearer interaction with an app implemented by the user interface 146 of the external electronic device 140 can be detected and monitored by the hearing system. For example, the hearing system can detect when the wearer activates a help mode of the app and the features that are subject to a help inquiry.

The use of a voice assistant provided by the hearing system can be detected and monitored by the hearing system. For example, the hearing system can detect a wearer's question concerning a particular feature or device setting. The hearing system can also detect a request made via the voice assistant to activate, deactivate or adjust a particular feature or setting(s) of the hearing system.

The hearing system can detect the use of an external resource that is coupled to the hearing system. For example, use of a table microphone, which can be communicatively coupled to the hearing device, can be detected by the hearing system.

Powering on or off of the hearing device can be detected and monitored by the hearing system. Powering off of the hearing device can be detected in response to wearer activation of a switch of the hearing device or placing the hearing device in a charger unit. Powering on the hearing device can be detected in response to wearer activation of a switch of the hearing device. The start of hearing device usage by the wearer (when positioned at the ear) can also be detected, such as by use of an optical proximity sensor or skin contact sensor of the hearing device. A sampling (snapshot) of the acoustic environment can be captured at the start of hearing device usage by the wearer. The sampling can be used to automatically select, or recommend to the wearer, hearing device settings appropriate for the acoustic environment.

The following are representative examples of the context of the wearer when using the hearing device. The context of the wearer can involve the acoustic environment of the wearer when using the hearing device. Aspects of the acoustic environment that can impact the wearer's listening experience include the signal-to-noise ratio (or similar metric), the type of noise in the acoustic environment, and the classification of the acoustic environment. For example, the hearing device can classify the acoustic environment as one that comprises noise, speech in noise, speech in quiet, music, and speech in music, among others. The hearing device 100 and/or the external electronic device 140 can include a classification module for classifying the acoustic environment as disclosed in U.S. Patent Application Publication No. 2011/0137656, which is incorporated herein by reference.

The context of the wearer can involve the activity status of the wearer (e.g., walking, running, biking, sitting). The hearing device 100 can include a motion sensor (e.g., IMU, accelerometer, gyroscope), alone or in combination with one or more physiologic sensors (see listing above), to determine the activity status of the wearer. The controller 110 of the hearing device 100 can be configured to implement an activity classification algorithm to determine the activity status of the wearer.

The context of the wearer can involve the location of the wearer, which can be determined using a beacon or a GPS sensor of the hearing device 100 or external electronic device 140. The context of the wearer can involve the time of day, which can be determined by the external electronic device 140. The context of the wearer can involve determining the emotional status of the wearer, which can be determined using EEG signals acquired by an EEG sensor of the hearing device 140. The hearing system can be configured to determine the emotional status of the wearer in a manner disclosed in U.S. Pat. No. 9,532,748, which is incorporated herein by reference.

The context of the wearer can be based on the health status of the wearer. The health status of the wearer can be determined based on one or more physiologic signals acquired by sensor(s) of the hearing device, examples of which are described above. For example, the health status of the wearer can be determined based on heart rate variability, body temperature and/or blood pressure.

The context of the wearer can be based on conversational patterns detected by the hearing device 100 or the external electronic device 140 when the wearer is speaking with other persons. For example, the hearing system can detect words or phrases indicative of a request by the wearer to a person to repeat themselves (e.g., “Can you say that again?”, “Can you repeat that?”). The conversational patterns can be detected by the hearing system as speech patterns in noise or difficulty of communicating in noise, such as by detecting an increase in the vocal effort of the wearer when speaking in noise (e.g., the Lombard effect). Other conversational patterns can be detected by the hearing system such as turn-taking, in which the participants in a conversation speak at one time in alternating turns.

The context of the wearer can be based on listening intent. For example, the listening intent of the wearer can be based on listening preferences implemented by an adaptive tuning feature of the hearing system, such as “best overall sound,” “enhance speech,” or “reduce noise.”

The changes to the hearing system operation may include any of those previously described. For example, such changes to the hearing system operation include an activation of, or change to, an adaptive tuning feature, and activation of, or change to, a noise suppression feature, and activation of, or change to, a tinnitus feature, a volume (gain) increase or decrease, and a change to a frequency distribution (e.g., increase higher frequencies or reduce lower frequencies).

The change to the hearing system operation may be directly implemented in the hearing system, for example by making a change to a hearing device setting or parameter, activating or deactivating a feature, or a prompt may be delivered to the wearer to accept a pending change (e.g., “Activate adaptive tuning now?” or “Activate comfort mode now?”). Alternatively, the change to the hearing aid operation may be delivered as a recommendation to the hearing device wearer, for example through an audio notification through the hearing device, or in a message or notification on smartphone, watch, or other computing device, or as a similar notification to a hearing professional (e.g., through a patient management system).

The following are use case examples of hearing device adaptation based on inferences from user interaction and the context of hearing device usage in accordance with any of the embodiments disclosed herein. The use case examples refer to a hearing system, which can be a hearing device alone or in combination with an external electronic device (see FIG. 1).

### Volume Increase in Speech-In-Noise

If a wearer increases the volume in the context of speech-in-noise, an inference may be made that the wearer is trying to better hear speech. The hearing system may invoke an operational change such as a shift toward more clarity (e.g., enhance speech mode) or prompt such a shift. The hearing system may activate an intelligibility feature, such as a deep neural network based speech enhancement feature as disclosed in any of U.S. Patent Application Publication Nos. 2023/0292074, 2023/0362559, and 2023/0276182, each of which is incorporated herein by reference. The operational change may additionally or alternatively include a shift to a directional mode for operating one or more microphones of the hearing device, such as in the manner disclosed in any of U.S. Pat. Nos. 9,749,754, 9,763,016, 9,949,041, and 10,425,745, each of which is incorporated herein by reference. The hearing system may activate an adaptive tuning feature, as disclosed in previously incorporated U.S. Patent Application Publication Nos. 2022/0369048 and 2023/0353957, and U.S. Pat. No. 12,035,107.

### Volume Decrease in Noise

If a wearer decreases a volume in noise, an inference may be made that the wearer desires more comfort, i.e., more noise reduction. An operational change of the hearing system may include an activation of a noise reduction feature or a strengthening of a noise reduction feature (i.e., reduce noise more, potentially at the expense of less clarity or more distortion).

### Volume or Memory Change in Specific Spectral Environment

A characteristic of the acoustic environment is the spectral shape of the environment (i.e., the frequency distribution of sound in the environment). A volume change or a memory change made by the wearer may suggest a need to make a gain assessment at the frequency bin level, e.g., to increase or decrease the gain for particular frequency bins. This may be implemented as an operational aid responsive to the volume or memory change, in combination with detection of a specific spectral environment.

### Equalizer Settings

Equalizer setting changes made by the wearer are an indicator of whether the settings are appropriate in different frequency regions (e.g., bass, middle, treble). For example, increasing high frequencies in the equalizer by the wearer indicates that there is insufficient gain in the high frequencies. Changes made to the equalizer setting by the wearer may cause the hearing system to perform one or more actions. For example, the hearing system may inform the hearing professional that the wearer may not have enough high frequency gain. The hearing system may suggest that the hearing professional generate an updated audiogram for the wearer. The hearing system may recommend to the wearer that a self-fitting check be performed by the wearer via the hearing system. The hearing system may provide to the wearer the option to apply the equalizer settings across other memories or features. In some examples, manipulation of indicator settings alone (without respect to context) may be used as a trigger to suggest a change to an operation of the hearing device, such as an updating of an audiogram for the wearer.

Changes made by the wearer to the equalizer settings can be detected along with the input spectrum associated with an acoustic environment. The hearing system can record the equalizer changes made for a particular input spectrum and apply these changes in future scenarios involving detection of the particular input spectrum. The hearing device may perform other processes when detecting equalizer changes for a particular input spectrum, including recommending to a hearing professional that modification of hearing device settings are needed, suggesting to the wearer that a self-fitting check be performed, or providing to the wearer the option to apply the equalizer settings across other memories or features.

Use of Acoustic Environment Information when Adaptive Tuning Feature is Activated

The hearing system may learn the wearer's device settings preferences for an acoustic environment based on wearer interactions with the hearing system when the adaptive tuning feature is activated. The hearing system may learn the wearer's preferences and activate the adaptive tuning feature automatically based on the learned preferences, examples of which are disclosed in previously incorporated U.S. Patent Application Publication Nos. 2022/0369048 and 2023/0353957, and U.S. Pat. No. 12,035,107. The adaptive tuning feature can be automatically activated by the hearing system in a particular context. The hearing system may provide a recommendation to the wearer to activate the adaptive tuning feature in a specific context. The learned preferences can be used to modify the adaptive tuning feature automatically based on those preferences. Wearer interactions with the hearing system can be captured, and these interactions can be used to modify the adaptive tuning feature (e.g., match the change made by the interaction or infer the wearer's preference from the interaction).

Inform/Teach Adaptive Tuning Feature with Wearer Preferences

Equalizer settings and changes made thereto in an adaptive tuning feature session may change offsets (frequency settings) in future adaptive tuning feature sessions. The changes made to the adaptive tuning feature via the equalizer settings can evolve over time. Recent changes made to the equalizer settings can be weighed more heavily than older changes.

### Creating Custom Memory in an Acoustic Context

When the wearer of the hearing device creates a custom memory from current settings for a particular context, the hearing system can infer that the wearer likes those settings in the particular context. The settings from the custom memory are saved and can be used to inform adaptive tuning or other features.

### Turning Off Adaptive Tuning in an Acoustic Context.

Turning off adaptive tuning in an acoustic context suggests dissatisfaction with adaptive tuning or lack of need of adaptive tuning in that context. The hearing system can use the acoustic classification prior to the activation as an input or trigger to deactivate or modify adaptive tuning.

### Wearer Interaction+Acoustic Context-Suggest Adaptive Tuning Feature in Acoustic Context

The hearing system may detect wearer interactions in a particular acoustic context. In response, the hearing system may make a recommendation to the wearer to the activate adaptive tuning feature as a solution to the problem they are having in the situation. For example, detecting wearer interactions in a particular acoustic context can trigger an alert in the app for the wearer, which can include a recommendation to activate the adaptive tuning feature.

### Detect Change in Wearer Hearing Based on Interactions in a Particular Context.

If the wearer is making numerous volume increases, especially in an acoustic context where such changes were not previously needed, and/or where a self-check feature has confirmed that the hearing device is working properly (e.g., not clogged with wax), this may indicate that the wearer's hearing has degraded (hearing loss has advanced), and so there may be a need for adjustments to the hearing device. In response, the hearing system may make a recommendation to the wearer via the app that an appointment with a hearing professional should be made. The hearing system may make a recommendation that the wearer perform a self-fitting or self-assessment procedure through use of the app or the hearing device.

### Detect a Change in the Pattern of Wearer Interactions in a Particular Context.

The hearing system can monitor the pattern of wearer interactions with the hearing system in a particular context. A change in the pattern (e.g., temporal pattern) of wearer interactions in a particular context may be indicative of an anomalous condition of the hearing device. For example, if a marked increase in the number of interactions with the hearing system is detected, this may be indicative of a foreign material problem, such as wax in the acoustic pathway of the hearing device. A change in the pattern of wearer interactions with the hearing system may indicate that the wearer's hearing loss has changed. It is noted that changes in the pattern of wearer interactions of the hearing system may be observed overall, as opposed to in a specific context.

### Wearer May be Classified as a “Frequent Interactor,” “Occasional Interactor” or “Rare “Interactor”

The hearing system may implement an algorithm that classifies the wearer of the hearing device as a particular type of interactor based on the frequency of interactions with the hearing system. The classification may be based on the number of interactions with the hearing system over a specified period of time (e.g., a specified number of hours, a day or days). Based on the frequency of interactions and thresholds established for the different types of interactors, the wearer may be classified by the hearing system as a frequent interactor, an occasional interactor or a rare interactor.

In some cases, a frequent interactor may be a wearer who prefers to make frequent changes to hearing device settings and/or activate/deactivate various features while being satisfied with the performance of the hearing device. In other cases, a frequent interactor may be a wearer who is attempting to remedy a problem with the hearing device, indicating dissatisfaction with the performance of the hearing device. In either scenario, the hearing system can communicate a message to the wearer asking them if the hearing device is operating in an acceptable manner. If the wearer responds negatively, the hearing system can recommend a course of action (e.g., turn on the adaptive tuning feature) or indicate via a message that the hearing system will make an automatic change to the hearing device operation to ameliorate the problem.

In the case of an occasional or rare interactor, a high level of hearing system interaction suggests that a change to hearing device operation needs to be made. The change to hearing device operation can be made automatically by the hearing system or in response to an input from the wearer responsive to a recommended course of action provided by the hearing system.

Wearer Interaction in Context where Hearing Device is not Property Fit.

The hearing device can include a motion sensor, such as an IMU, to detect whether the hearing device is properly fit (e.g., properly positioned at the ear of the wearer), as is disclosed in U.S. Patent Application Publication No. 2022/0386048, which is incorporated herein by reference. The hearing device can include an IMU in each of a left hearing device and a right hearing device. The hearing system may determine that left and right hearing devices are properly positioned at the ear of the wearer based on IMU signals indicating synchronized motion in one or more patterns consistent with movements of the human head (e.g., nodding, rotating, tilting, head movements associated with walking, etc.). The hearing system may determine that left and right hearing devices are not properly positioned at the ear of the wearer based on IMU signals that lack an indication of synchronized motion. The hearing system avoids making adjustments to hearing device operation if the problem is the physical fit of the left and/or right hearing devices. The hearing system can generate a message recommending that the wearer reposition the left and right hearing devices in response to determining that the problem is a physical fit of the hearing devices.

### During Acclimation, Trend Over Time for an Interaction or Specific List of Interactions

As discussed previously, wearer interaction with the hearing device can involve increasing the volume or gain. The hearing device can implement a process of acclimation in which the hearing device gain is slowly turned up over time, to give the wearer time to acclimate to the gain changes. For example, the hearing device gain can be incrementally increased over a period of a few weeks. The hearing system can determine how the acclimation is going for the wearer. Wearer interactions with the hearing system can be used to gauge where the wearer is in their acclimatization phase so that the hearing system adjusts the gain appropriately.

The rate of increase of hearing device gain can be adjusted based on wearer interactions with the hearing system (adaptive acclimatization). For example, the rate of increase of hearing device gain can be adjusted upwardly in response to the wearer turning up the volume on a repeated basis, which is an indicator that the acclimation is too slow for the wearer. The rate of increase of hearing device gain can be adjusted downwardly in response to the wearer turning down the volume on a repeated basis, which is an indicator that the acclimation is too fast for the wearer. Other parameters can be subject to the process of acclimation, such as noise suppression or changes made to an equalizer.

### Detect an Uptick in Wearer Interaction Over Time

Detecting an uptick in wearer interaction with the hearing device in a particular context may indicate that an operational change is needed. In response to detecting an uptick in wearer interaction with the hearing device, the hearing system may automatically activate a feature or strengthen a currently active feature.

For example, detecting an uptick in volume increase in a context or activation of the adaptive tuning feature in a context can cause the hearing device to change the directionality of the microphones of the hearing device. In some cases, microphone operation can be switched from an omnidirectional mode to a directional mode. In other cases, microphone operation can be switched from a directional mode to an omnidirectional mode. The change of microphone directionality can include a change in the direction of the beam, such as by steering the null to noise in the acoustic environment. Changing the directionality of the hearing device microphones can be implemented in the manner disclosed in U.S. Pat. No. 8,824,711, which is incorporated herein by reference.

Detecting an uptick in volume decrease in a context can cause a change to noise reduction, such as by lowering the noise threshold for automatic activation of noise reduction.

Detecting an uptick in wearer interaction with a hearing device in a particular context can cause the hearing system to generate a notification suggesting that the wearer engage with an app-based expert assistant to help resolve any issues with hearing device operation. The hearing system may alternatively, or in addition, recommend that the wearer engage with a hearing professional to seek an operational change to the hearing device. The hearing system may notify a caregiver or hearing professional with a suggestion that they engage with the wearer to help resolve any issues with the hearing device operation.

### Detect an Uptick in Wearer Interaction in a Particular Context

The hearing system may detect an increase in wearer interaction with the hearing device in a particular context, and engage with the wearer via the app to facilitate an appropriate adaptation to hearing device operation. The hearing system may generate a message to a hearing professional that an adaptation to hearing device operation is needed in response to detecting an increase in wearer interaction with the hearing device in a particular context. The increase in wearer interaction with the hearing device in a particular context may indicate that the wearer has developed a new preference. The hearing system may facilitate a change to hearing device operation to adapt to the new preference.

### Machine Learning of Wearer Behavior or Preferences

A machine learning algorithm can be implemented by the hearing system to learn typical wearer interactions with the hearing device in a particular context. The hearing system can detect a deviation from the typical wearer interactions (anomalies) in the particular context. Detection of such a deviation can trigger a learning event, in which the manual response of the wearer to the anomalous context is captured. Detection of the deviation can trigger an adaptation by the hearing system to change the operation of the hearing device.

### Cognitive Load Detection

The hearing system may be configured to detect the cognitive load of the hearing device wearer as related to a particular context. An increase in the wearer's cognitive load can be detected based on social inactivity (e.g., non-participation in a conversational situation) and/or from physiologic signals acquired by one or more physiologic sensors of the hearing device (e.g., heart rate variability, body temperature, EEG signals).

In response to detecting increased cognitive load for a particular context, the hearing system may adjust the hearing device to increase clarity (e.g., activate an intelligibility feature) or reduce noise to increase comfort. The hearing system may learn the wearer's preference for clarity or comfort in a particular context based on whether the wearer turns the volume up or down in a situation where increased cognitive load has been detected. The hearing system may generate a message for a hearing professional recommending an adjustment to hearing device operation.

The hearing system can track the wearer's cognitive load as related to particular contexts. If the hearing system detects an increase in the wearer's cognitive load for a particular context, the hearing system may generate a recommendation for the wearer suggesting an operational change to the hearing device be made to provide more hearing assistance. The hearing system may generate a recommendation for a caregiver or hearing professional suggesting they intervene to provide assistance or therapy.

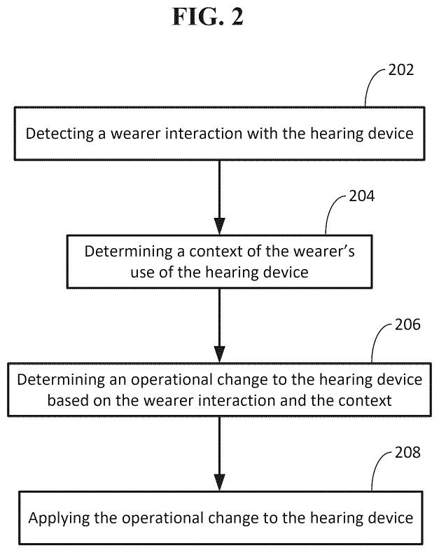

FIG. 2 illustrates a method implemented by a hearing system comprising a hearing device worn by a wearer in accordance with any of the embodiments disclosed herein. The method comprises detecting 202 a wearer interaction with the hearing device, and determining 204 a context of the wearer's use of the hearing device. The method also comprises determining 206 an operational change to the hearing device based on the wearer interaction and the context. The method further comprises applying 208 the operational change to the hearing device.

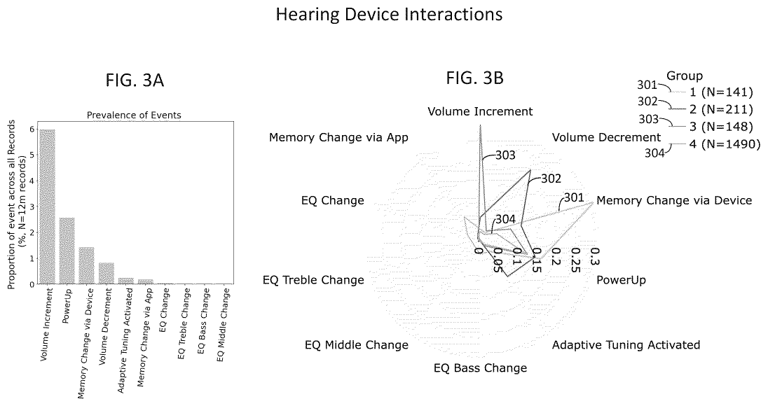

FIGS. 3A-6C are directed to an analysis of hearing device interactions by different groups of hearing device wearers. The analysis is based on a large number of hearing device wearers that were randomly chosen for the analysis based on certain criteria. Data was obtained from the wearer's device log and app interactions, encompassing a number of device interactions and acoustic environment characteristics. A hierarchical clustering method was used to group the hearing aid wearers based on device interaction behaviors. Four distinct groups were identified.

Modern hearing devices (e.g., hearing aids) provide extensive flexibility and parameterization to enhance a user's listening experience. While most hearing device settings are configured by professionals (e.g., clinicians), end-user customization is enabled through on-device controls and mobile (e.g., smartphone) apps. A key challenge for hearing device manufacturers is creating user interfaces that are both intuitive and effective in fine-tuning the hearing device to meet individual needs. FIGS. 3A-6C are directed to the concept that user interfaces for user-driven fine-tuning can be customized for different user groups based on observable factors. By analyzing detailed user interaction data through a smartphone app and a multiplicity of hearing devices, various hypotheses can be tested, examining how usage patterns reflect factors such as listening context and hearing device experience.

### Example

### User Selection:

An experiment was conducted based on 1,991 hearing aid app users which were randomly chosen based on the following criteria: use of bilateral hearing aids; app and hearing aid use in excess of 30 days; and minimum weekly connection to the app.

### Data Domains:

Data was obtained from users' hearing aid log and app interactions, encompassing: device interactions (volume adjustments made by users, switching between environment-specific settings (memory changes), and use of available app processing features), and acoustic environment characteristics.

### Grouping Method:

A hierarchical clustering method was used to group hearing aid wearers based on device interaction behaviors. Four distinct groups were identified: Group 301=141 users (7%), Group 302=211 users (11%), Group 303=148 users (7%), and Group 304=1490 users (75%).

FIGS. 3A and 3B show hearing aid interactions based on the acquired user data. FIG. 3A shows the prevalence of hearing aid interaction events across all records (N=12 million records). The hearing aid interaction events include Volume Increment, PowerUp, Memory Change via Device, Volume Decrement, Adaptive Tuning Activated, Memory Change via App, Equalizer (EQ) Change, EQ Treble Change, EQ Bass Change, and EQ Middle Change.

FIG. 3B shows the hearing aid interaction profile of each group (Groups 301, 302, 303, 304). All hearing aid events have been scaled between 0-1. Most users are clustered into Group 304, where hearing aid interactivity is relatively low. The Group 301 users can be seen to employ memory settings and the equalizer (EQ). The Group 302 users exhibit relatively more volume decreases and adaptive tuning activation. The Group 302 users can be seen to increase volume more frequently than those in other groups.

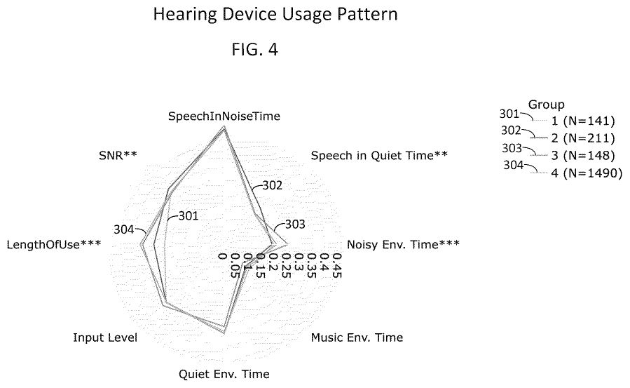

FIG. 4 shows the hearing aid usage pattern of each group including average time spent in each acoustic environment, input level, signal-to-noise ratio (SNR), and length of use of the hearing aid. The different acoustic environments include speech in noise, speech in quiet, noisy environment, music environment, and quiet environment. The data shown in FIG. 4 is scaled between 0-1 using a minmax scaler for each metric.

As can be seen in FIG. 4, the length of hearing aid use is a significant differentiator between groups, with Groups 303 and 304 using the device for a longer time (mean=142 and 145 days respectively) compared to Groups 301 and 302 (mean=106 and 123 days respectively). Group 302 spends more time in higher SNR environments, especially in quiet speech settings. Group 303 tends to spend slightly more time in lower SNR environments, particularly in noisy environments.

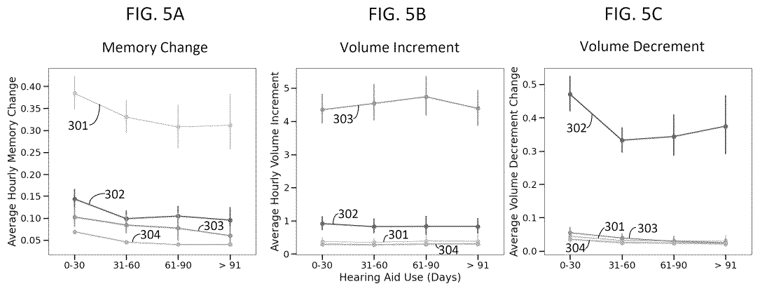

FIG. 5A shows the average hourly memory change for each group as a function of length of use. FIG. 5B shows the average hourly volume increment for each group as a function of length of use. FIG. 5C shows the average volume decrement for each group as a function of length of use.

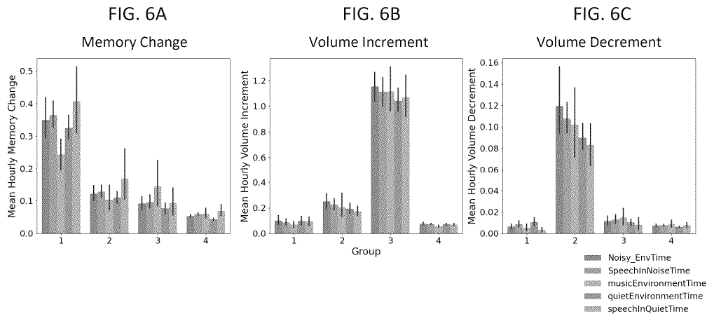

FIGS. 6A-6C show memory change, volume increment, and volume decrement data for five different acoustic environments for each group. The five different acoustic environments are (from leftmost bar to rightmost bar): noisy environment, speech in noise environment, music environment, quiet environment, and speech in quiet environment. FIG. 6A shows the mean hourly memory change in the five acoustic environments. FIG. 6B shows the mean hourly volume increment in the five acoustic environments. FIG. 6C shows the mean hourly volume decrement in the five acoustic environments.

As is seen in FIG. 6A, memory changes occur across all environments in Group 301, with a slight increase in the speech in quiet environment. Given that the Group 301 users interact with their hearing aids more than other groups, these users may be simply testing features and memories. There is little difference in volume increase events across acoustic environments in Group 303, which may indicate hearing aid underfitting. Group 302, which exhibits more volume decreases than other groups, tends to decrease their volume more in noisy environments.

The comprehensive data gathered from the selected set of hearing aids and the mobile app has enabled the investigation of hearing aid usage patterns. The data show that a large percentage of hearing aid users do not interact with their devices, suggesting satisfaction with their hearing aid settings and automatic adaptations. The data shows noticeable difference in groups of uses that interact with their devices, which appear to be driven by users' level of experience and the acoustic environments they frequent. User interaction behaviors may reflect their adjustment preferences, but may also be indicative of suboptimal listening experience through the hearing aid.

Analyzing user interaction behavior can be useful for proactively addressing issues or automatically adjusting the hearing aid to better align with user preferences. In an example, a hearing system comprising a hearing device can be configured to detecting a wearer interaction with the hearing device, determine a context of the wearer's use of the hearing device, obtain user data for groups of a population of hearing device users based on user interaction with, and context of use of, the users' hearing devices, determine an operational change to the hearing device based on the wearer interaction, the context, and the user data that corresponds to the wearer's interaction and context, and apply the operational change to the hearing device.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The terms “connected” or “coupled” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. A method implemented by a hearing system comprising a hearing device worn by a wearer, the method comprising:
detecting a wearer interaction with the hearing device;
determining a context of the wearer's use of the hearing device;
obtaining user data for groups of a population of hearing device users based on user interaction with, and context of use of, the users' hearing devices;
determining an operational change to the hearing device based on the wearer interaction, the context, and the user data that corresponds to the wearer's interaction and context; and
applying the operational change to the hearing device.

2. The method of claim 1, wherein applying the operational change to the hearing device comprises adjusting the sound output by the hearing device.

3. The method of claim 1, comprising one or both of:
generating and delivering a notification to the wearer suggesting or offering the operational change to the hearing device; and
generating and delivering a notification to a hearing professional suggesting the operational change to the hearing device.

4. The method of claim 1, wherein the hearing system comprises the hearing device communicatively coupled to an external electronic device, and the method is implemented by cooperative operation of the hearing device and the external electronic device.

5. The method of claim 1, wherein the context comprises one of both of an acoustic context and an activity context of the wearer.

6. The method of claim 1, wherein the context comprises one or both of a location of the wearer and time of day.

7. The method of claim 1, wherein the context comprises one or both of an emotional status of the wearer and a health status of the wearer.

8. The method of claim 1, wherein the context comprises one or both of conversational patterns involving the wearer and a listening intent of the wearer.

9. The method of claim 1, wherein the wearer interaction comprises one or both of wearer manipulation of a user interface of the hearing device and wearer manipulation of an app implemented by a user interface of an external electronic device communicatively coupled with the hearing device.

10. The method of claim 1, wherein the wearer interaction comprises one or more of:
changing a volume of the hearing device;
activating, deactivating, and/or adjusting a feature of the hearing device.
changing a memory of the hearing device; and
tuning an equalizer of the hearing device.

11. The method of claim 1, wherein the wearer interaction comprises one or more of:
activating, deactivating, and/or adjusting a noise suppression feature of the hearing device;
activating, deactivating, and/or adjusting an adaptive tuning feature of the hearing device;
activating, deactivating, and/or adjusting a tinnitus masking feature of the hearing device;
activating and deactivating a stream boost feature of the hearing device; and
powering on the hearing device and powering off the hearing device

12. A hearing system, comprising:
a hearing device configured to be worn by a wearer, the hearing device comprising one or more microphones, an acoustic transducer, audio circuitry coupled to the one or more microphones and the acoustic transducer, and a controller coupled to the audio circuitry, the controller configured to:
detect a wearer interaction with the hearing device;
determine a context of the wearer's use of the hearing device;
obtain user data for groups of a population of hearing device users based on user interaction with, and context of use of, the users' hearing devices;
determine an operational change to the hearing device based on the wearer interaction, the context, and the user data that corresponds to the wearer's interaction and context; and
apply the operational change to the hearing device.

13. The system of claim 12, comprising an external electronic device communicatively coupled with the hearing device, the external electronic device comprising a user interface configured to implement an app for interacting with the hearing device.

14. The system of claim 12, wherein applying the operational change to the hearing device by the controller comprises adjusting the sound output by the acoustic transducer.

15. The system of claim 12, wherein the controller is configured to:
generate and deliver a notification to the wearer suggesting or offering the operational change to the hearing device; and/or
generate and deliver a notification to a hearing professional suggesting the operational change to the hearing device.

16. The system of claim 12, wherein the context comprises one of both of an acoustic context and an activity context of the wearer.

17. The system of claim 12, wherein the context comprises one or both of a location of the wearer and time of day.

18. The system of claim 12, wherein the context comprises one or both of an emotional status of the wearer and a health status of the wearer.

19. The system of claim 12, wherein the context comprises one or both of conversational patterns involving the wearer and a listening intent of the wearer.

20. The system of claim 12, wherein the wearer interaction comprises one or more of:
changing a volume of the hearing device;
activating, deactivating, and/or adjusting a feature of the hearing device.
changing a memory of the hearing device; and
tuning an equalizer of the hearing device.

21. The system of claim 12, wherein the wearer interaction comprises one or more of:
activating, deactivating, and/or adjusting a noise suppression feature of the hearing device;
activating, deactivating, and/or adjusting an adaptive tuning feature of the hearing device;
activating, deactivating, and/or adjusting a tinnitus masking feature of the hearing device;
activating and deactivating a stream boost feature of the hearing device; and
powering on the hearing device and powering off the hearing device.
